(19) United States
(12) Patent Application Publication
(10) Pub. No.: US 2009/0233573 A1
(43) Pub. Date: Sep. 17, 2009

(54) Portable Emergency Position Location Data Logging Communications Terminal

(76) Inventor: Anthony M. Gray, Tampa, FL (US)

Correspondence Address: GRAY ROBINSON, P.A., P.O. Box 2328, FT. LAUDERDALE, FL, 33303-9998, US

(21) Appl. No.: 12/045,823

(22) Filed: Mar. 11, 2008

(51) Int. Cl. H04M 11/04

(52) U.S. Cl. 455/404.2

(57) ABSTRACT

A portable voice and data communications device capable of logging and transmitting position location data. The system consists of a transceiver and processor that receive, calculate, store, and transmit position location information from the global positioning system (GPS) and/or from a built in inertial navigation system (INS). The device has an emergency distress button that, when pushed by the user of the invention, sends an emergency distress notification, via cellular or satellite data communications links, to multiple preconfigured recipients as a text message and is represented on an internet based map display. The device can be configured to operate in two possible modes of operation. One mode of operation allows the user of the invention to constantly stream their position location information to the map display. The alternate mode of operation allows users to keep their location discreet with a position location data logging mode of operation that only transmits their existing location and a preset number of locations stored in the data logger when the emergency distress button is pushed. Upon activation of the emergency distress button, the device automatically defaults to the position location streaming mode of operation. Users of the invention may also be able to use the device for two way voice and text message communications in order to facilitate resolution of an emergency distress situation or for non-emergency communications.

### BACKGROUND OF THE INVENTION

1. Field of the Invention

The subject invention is generally related to mobile electronic communications and is specifically directed to a comprehensive mobile data communications solution particularly well suited for people in a high risk environment.

2. Discussion of the Prior Art

Portable emergency position location transmission devices in the art, such as the devices presented in U.S. Pat. Nos. 786,411 and 974,337, have the ability to send Global Positioning System (GPS) location information to a map display and a central dispatch station when an emergency distress button is pressed. In addition, portable communication devices in the art, such as cellular phones, are able to transmit position location information to a map display. Existing devices in the art have multiple deficiencies in emergency situations.

A major deficiency of devices in the art presents itself when line of site to the GPS satellite network is obstructed. In such situations, a GPS device is unable to determine location. Line of site to the GPS system may be obstructed by natural obstructions, such as dense forest coverage, or manmade obstructions, such as buildings.

Another major deficiency occurs when GPS devices are turned on. It can take many minutes for the device to initialize and determine location after a GPS device is turned on or activated from a standby mode.

Existing devices in the art are vulnerable to the above GPS technology deficiencies. If an emergency location device is unable to immediately report the location of the user, then the device may be ineffective in emergency response efforts. For example, if the user of such a device activates the emergency distress button when they are inside a building, with no line of site to the GPS satellites, the central dispatch station will not be able to identify their location. Another example would be if the user of such a device activates the emergency distress device from a powered off or standby mode, it may take anywhere from several moments or many minutes for the GPS location to be determined. Such deficiencies and delays could mean the difference between life and death for the user of such devices in a life threatening emergency situation.

Existing devices in the art do not allow the user of the device to control the reporting of their location. Since the device is always reporting the location of the user or is remotely controlled by a third party, the user is unable to control the privacy of their whereabouts. In order to cease transmitting their location to control the privacy of their whereabouts, users of devices in the art must power off their device. In an emergency distress situation, the device may likely be ineffective in identifying the location of the user either due to delays associated with the device attempting to power up and initialize or worse, the device may not be able to determine location due to natural or manmade obstructions to the GPS satellite system. Failure of the device to effectively power up and immediately send location information to the emergency dispatch center could mean the difference between life or death.

### SUMMARY OF THE INVENTION

The subject invention is directed to a portable personal alarm system. The user of the invention is able to carry the device anywhere and press the emergency distress button at any time. The invention can be operated by the user in two modes of operation. The first mode of operation allows the user of the invention to continually report their location to an emergency dispatch center where the location information is presented on a map display. The second mode of operation allows the user to only report their location information when the emergency distress button is pressed. This mode allows the user of the invention to prevent others from knowing their whereabouts until the emergency distress button is pressed. During this mode of operation, data logger circuitry in the invention stores the latest series of position locations. When the emergency distress button is pressed, the invention transmits the stored series of logged position locations to the emergency dispatch center.

In both modes of the operation, the emergency dispatch center is able to view the series of recent position locations on a map display. This allows the emergency center dispatcher the ability to identify and/or interpret the current location of the user. On screen prompts alert the emergency dispatcher to the emergency distress situation for the customer and their associated emergency contact information. In addition, text, email, and other message formats automatically transmit emergency notification messages to the user's preset emergency personal contacts. The user's personal contacts automatically receive the emergency distress messages indicating the user's name in distress and the user's current location. Once the emergency distress button is pressed, the invention continues to send automatic emergency distress position location updates to the emergency dispatch center and the user's preset emergency contacts until the emergency distress function is deactivated by the emergency dispatch center.

The device contains cellular and/or satellite phone circuitry that allows for two way communication between the user of the invention and the emergency dispatch center. When the emergency distress button is activated, the emergency center dispatcher can verbally communicate with the user of the invention either by speakerphone on the device or by holding the device to their ear and speaking into a microphone on the device. The emergency dispatch center may also forward or conference call the caller to or with other callers. This feature allows the emergency center dispatcher to ascertain the disposition of the user and identify if the emergency distress alert is indeed a valid alarm.

The components of the device are designed to fit in a casing the size of a pager or small cellular phone with a belt clip for attachment to the user's clothing or to the dashboard of the user's automobile. The device contains circuitry that receives GPS location information. In one embodiment of the invention, it may contain inertial navigation system (INS) circuitry that periodically synchronizes with the GPS systems and continues to calculate the location of the user when the line of site to the GPS satellite system is obstructed and prevents the receipt of GPS signals.

### BRIEF DESCRIPTION OF THE SEVERAL VIEWS OF THE DRAWING

FIG. 1 is a system design of the invention

FIG. 2 is an embodiment with a small screen above the speaker for representing alpha numeric characters for text messages.

FIG. 3 represents the invention operating in one mode of operation that constantly transmits position location information to the emergency dispatch center.

FIG. 4 Represents the invention sending the emergency distress notification to the emergency dispatch center and a preset group of emergency contacts.

FIG. 5 Represents the invention communicating with the emergency center dispatcher via voice communications.

FIG. 6 Represents the invention operating in the discrete mode whereby the internal circuitry data logger stores the most recent series of locations.

FIG. 7 Represents the emergency distress button being activated, while in discrete mode, and transmitting the stored series of recent locations and the current location to the emergency dispatch center.

FIG. 8 Represents the emergency distress button being activated, while in discrete mode, and transmitting only the stored series of recent locations to the emergency dispatch center.

FIG. 9 Represents an authorized individual with the ability to view the emergency dispatch center map display from the internet and see the current and recent locations of the user of the invention.

FIG. 10 Represents the ability of the user of the invention to exchange alpha numeric text messages with the emergency dispatch center and other individuals.

### DETAILED DESCRIPTION OF THE INVENTION

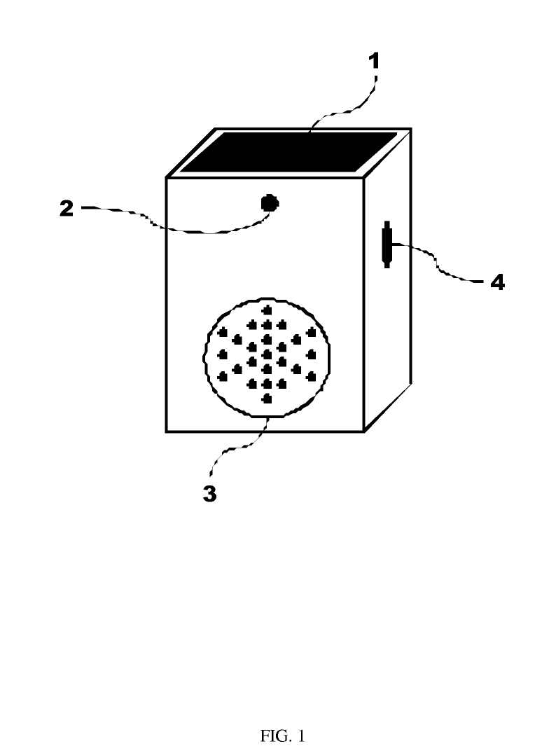

FIG. 1 depicts the preferred embodiment of the invention. The circuitry is housed in a box the size of a pager and can be worn on an article of clothing or clipped to another article such as a visor in an automobile. The emergency distress button 1 of FIG. 1 is of a size and positioning such that the user of the invention can easily press the button while in an emergency situation. When the emergency distress button 1 of FIG. 1 is pressed, a flashing or steady light will emit from the surface of the button serving as a visual indication that the emergency distress button has been pushed. A microphone 2 of FIG. 1 is used to allow the user of the invention to communicate with the emergency dispatch center when the emergency distress button is pushed. A speaker 3 of FIG. 1 is used to allow the user of the invention to hear voice communications. A feature setting button 4 of FIG. 1 allows the user of the invention to set the various modes of operation and adjust other features such as speaker volume. All physical items detailed above may be positioned at any location on the surface of the invention to accommodate for the best ease of use.

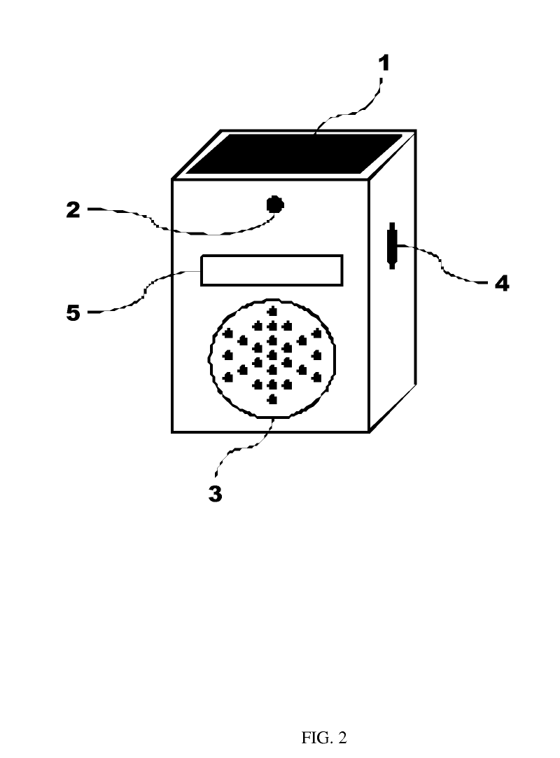

FIG. 2 depicts an embodiment of the invention with a screen 5 of FIG. 2 allowing the representation of alpha numeric characters. This screen can be used to show text messages from the emergency dispatch center or from other parties. This screen can also be used to represent various system settings and performance parameters such as the current mode of operation or satellite signal strength.

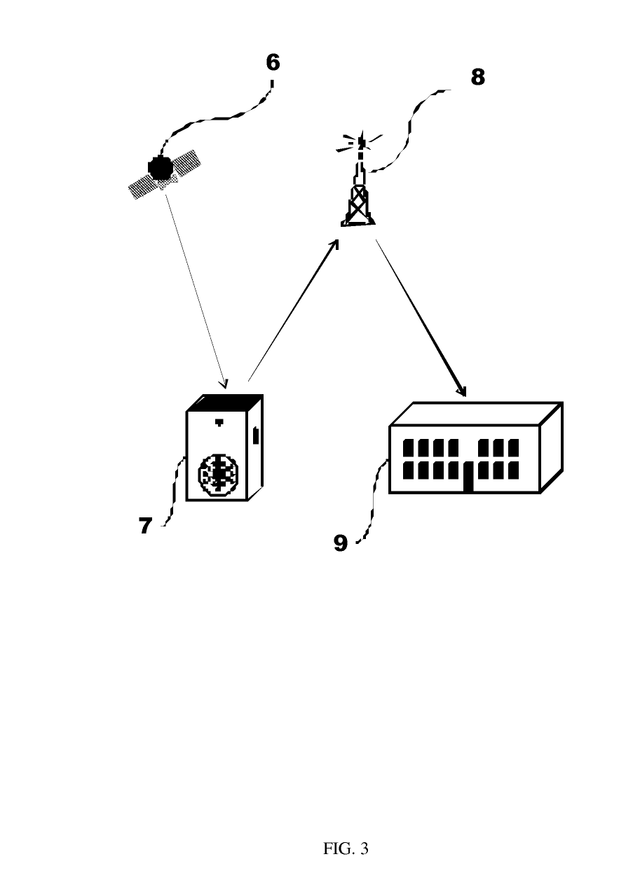

FIG. 3 depicts the invention operating in the mode of operation that constantly transmits position location to the emergency dispatch center. GPS satellite 6 of FIG. 3 transmits GPS data to the invention 7 of FIG. 3. The invention 7 of FIG. 3 automatically transmits the GPS position location data via a communications network 8 of FIG. 3. The emergency dispatch center 9 FIG. 3 receives the position location data and is presented on a map display.

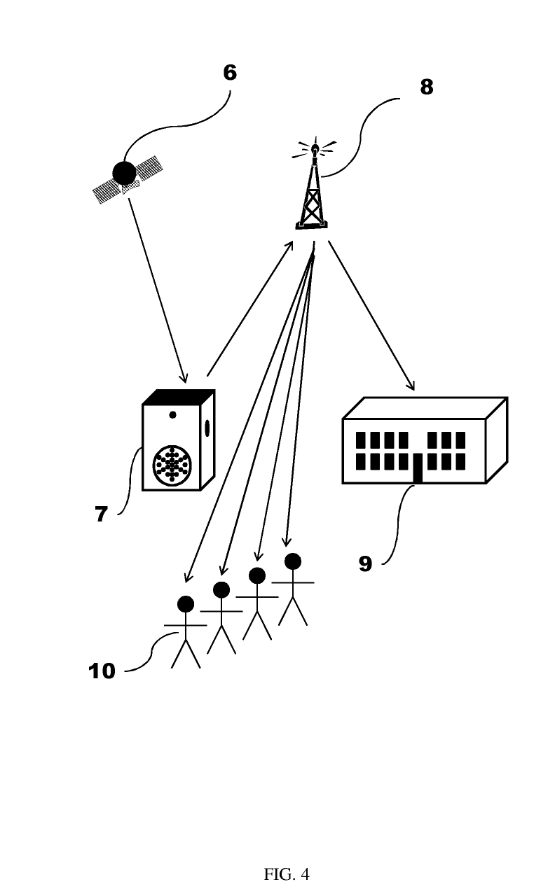

FIG. 4 depicts the invention operating with the emergency distress button activated. The emergency distress button 1 FIG. 1 is pressed on the invention 7 FIG. 3. The position location data from the GPS system 6 FIG. 3 is sent to the emergency dispatch center 9 FIG. 3 via the communications network 8 FIG. 3. One or many previously designated emergency points of contact 10 FIG. 4 receive an emergency distress notification message with the most recent location of the user of the invention. The invention 7 FIG. 3 continues to automatically report the latest position location of the user to the emergency dispatch center 9 FIG. 3 and the emergency points of contact 10 FIG. 4, at regular intervals, until the emergency center dispatcher remotely deactivates the emergency distress feature on the invention.

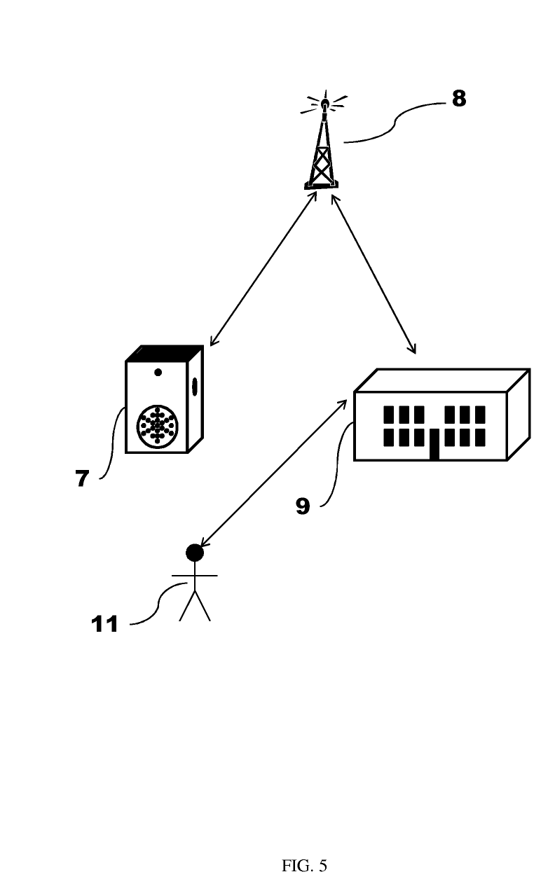

FIG. 5 depicts the emergency dispatch center 9 FIG. 3 verbally communicating with the user of the invention via a communication network 8 FIG. 3. The emergency dispatch center 9 FIG. 3 is also able to patch a caller through to the user of the invention for voice communications between the caller and the user of the invention.

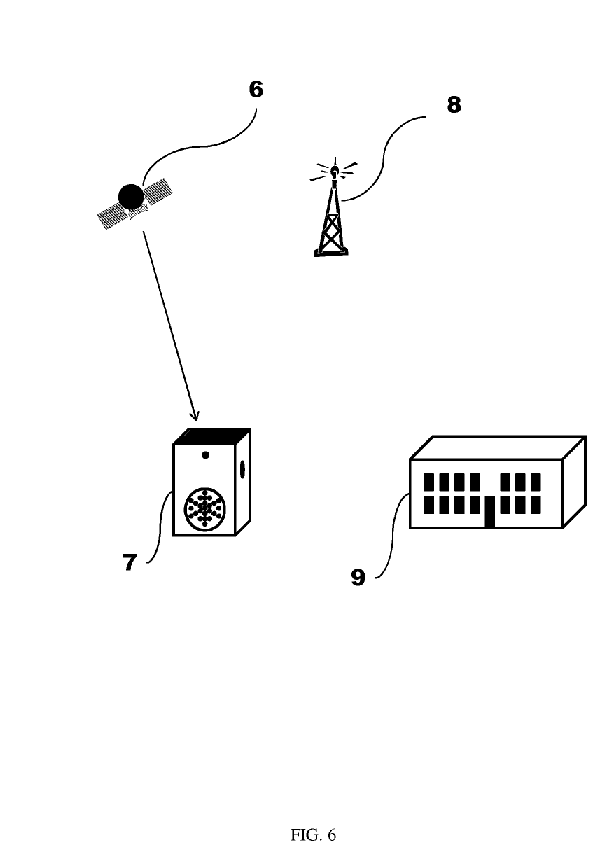

FIG. 6 depicts the invention operating in the discrete mode of operation. During this mode of operation, the data logger built into the circuitry of the invention 7 FIG. 3 receives and stores a series of GPS locations transmitted from the GPS system 6 FIG. 3. The INS system built into the circuitry of the invention 7 FIG. 3 synchronizes with the GPS location data received from the GPS system 6 FIG. 3. This discrete mode of operation does not transmit the position location data to the emergency dispatch center thus allowing the user of the invention to protect the privacy of their whereabouts.

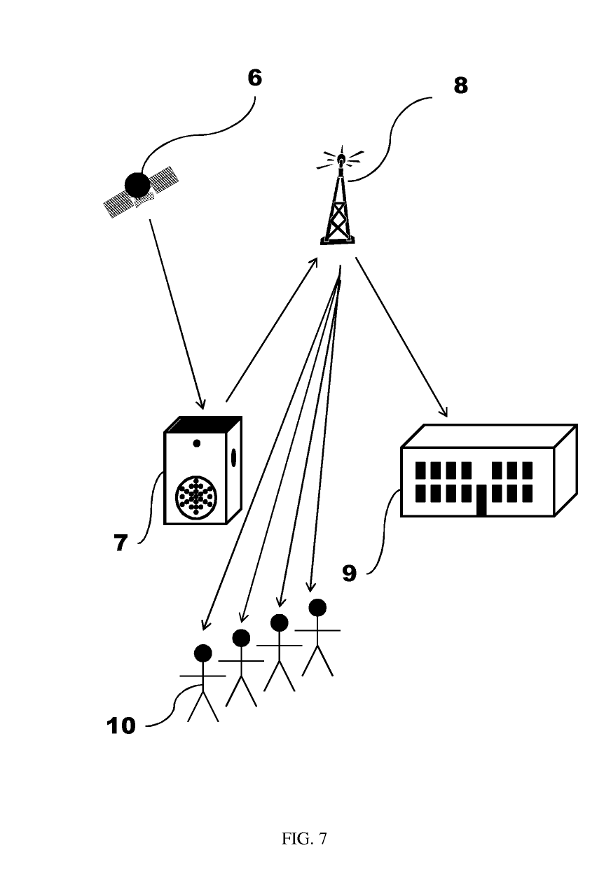

FIG. 7 depicts emergency distress button 1 FIG. 1 being pushed on the invention 7 FIG. 3 while the system is operating in discrete mode. When the emergency distress button is pressed 1 FIG. 1, the series of position locations stored in the data logger built into the circuitry of the invention 1 FIG. 3, is transmitted to the emergency dispatch center 9 FIG. 3 and one or many emergency points of contact 10 FIG. 4 via the communications network 8 FIG. 3. Once the emergency distress button 1 FIG. 1 is pushed, the GPS position location data is automatically transmitted to the emergency dispatch center 9 FIG. 3, at regular intervals, until the emergency center dispatcher deactivates the emergency distress feature on the invention.

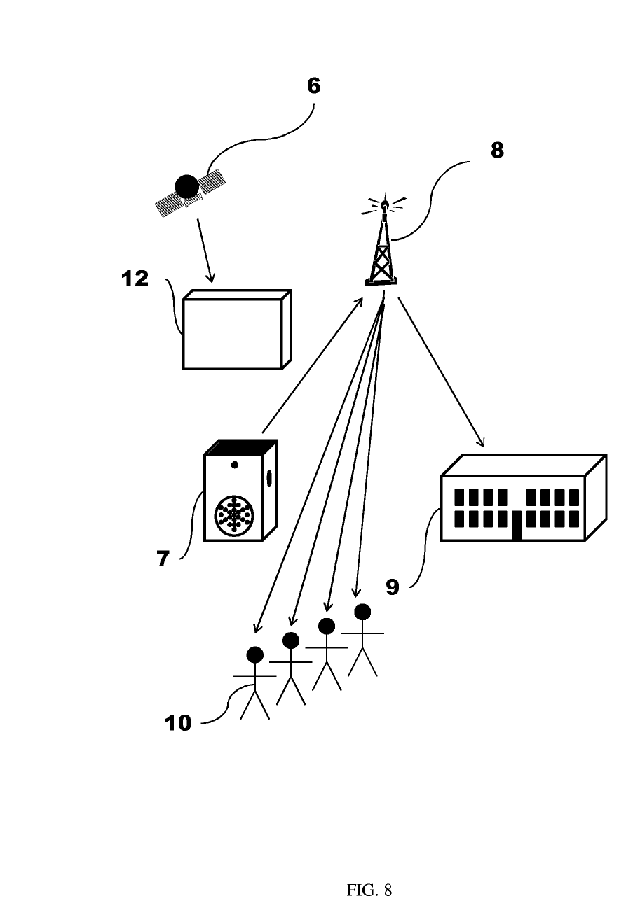

FIG. 8 depicts the invention 7 FIG. 3, while operating in the discrete mode, unable to receive GPS location data from the GPS system due to a natural or manmade obstruction 12 FIG. 8. When the emergency distress button 1 FIG. 1 is pressed on the invention 7 FIG. 3, the GPS and/or INS position location stored in the data logger of the invention 7 FIG. 3 is transmitted to the emergency dispatch center 9 FIG. 3 via the communications network 8 FIG. 3. In the embodiment of the invention with INS built into the device, the invention 7 FIG. 3 continues to automatically transmit the position location data, at recurring intervals, to the emergency dispatch center 9 FIG. 3 and the emergency points of contact 10 FIG. 4, via the communications network 8 FIG. 3, until the emergency dispatch center 9 FIG. 3 deactivates the emergency distress feature on the invention.

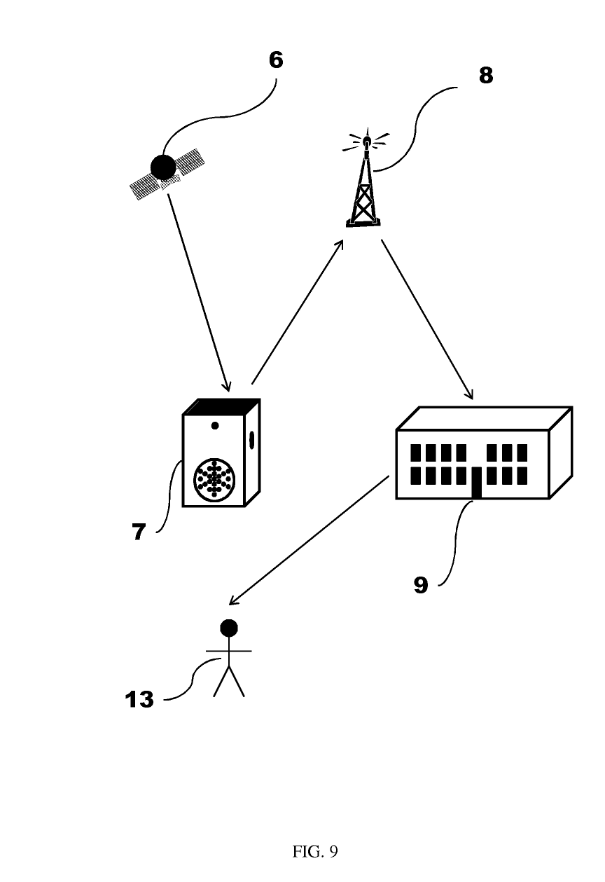

FIG. 9 depicts an authorized individual 13 FIG. 9 viewing the position location data of the user of the invention on the emergency dispatch center map display via the internet.

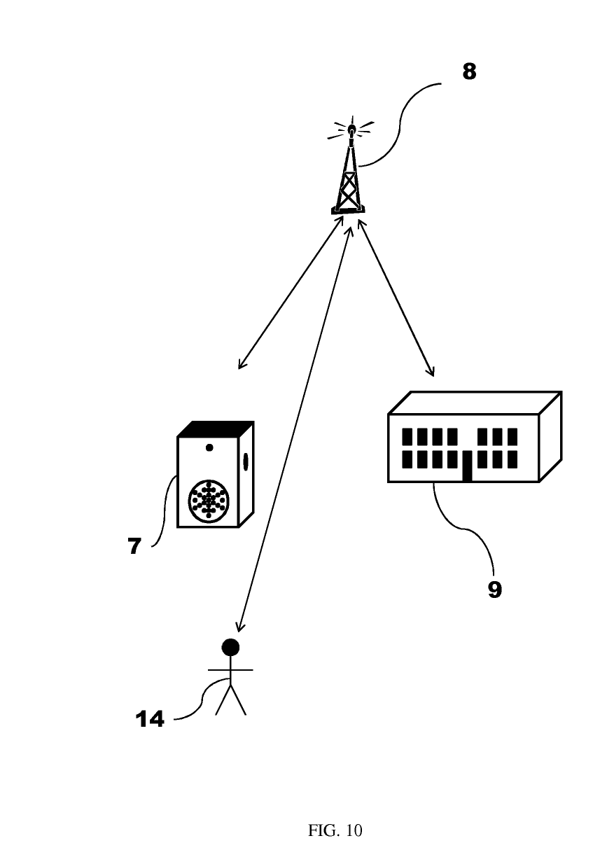

FIG. 10 depicts an individual 14 FIG. 10 communicating directly with the user of the invention 7 FIG. 3 and/or the emergency dispatch center 9 FIG. 3 via voice or messaging on the communications network.

We claim:

1. A portable emergency position location data logging communications terminal system, the system comprising:
(a) a portable device capable of sending an emergency distress signal
(b) an emergency distress button functionally related to the portable system such that when the button is pressed an alarm signal is generated and processed by,
(i) an emergency dispatch center that receives the emergency distress message,
(ii) an emergency center dispatcher capable of receiving the emergency distress message and interpreting the location data on a computer map display and identifying the latest location of the individual,
(iii) a verbal and data communication capability between the emergency center dispatcher and the user of the system,
(iv) a means for the emergency center dispatcher to connect callers directly to the system or connect multiple parties to a conference call,
(v) a means for alpha numeric messages to be transmitted to the system

2. The portable emergency position location data logging communication terminal system claimed in claim 1, wherein the user can select a mode of operating the system such that the system continually transmits position location at regular intervals.

3. The portable emergency position location data logging communication terminal system claimed in claim 1, wherein the user can select a discrete mode of operating the system such that the system does not transmit position location until the emergency distress button is pressed.

4. The portable emergency position location data logging communication terminal system claimed in claim 1, wherein the system conducts data logging of a series of most recent locations and this stored data is transmitted when the emergency distress button is pressed.

5. The portable emergency position location data logging communication terminal systems claimed in claim 1, wherein the system may process GPS and/or inertial navigation system (INS) position location information.

6. The portable emergency position location data logging communication terminal systems claimed in claim 1, wherein the position location information is transmitted to the emergency dispatch center via wireless data communications networks.

7. The portable emergency position location data logging communication terminal systems claimed in claim 1, wherein a light built into the circuitry of the system flashes when the emergency distress button is activated.

8. The portable emergency position location data logging communication terminal systems claimed in claim 1, wherein the system can be clipped to a personal article of clothing or some other object.

9. The portable emergency position location data logging communication terminal systems claimed in claim 1, wherein the system has a speaker and microphone for voice communications.

10. The portable emergency position location data logging communication terminal systems claimed in claim 1, wherein the system has a button for controlling features of the system such as speaker volume.

11. The portable emergency position location data logging communication terminal systems claimed in claim 1, wherein the system has a screen capable of showing alpha numeric characters and system status indicators.

12. The portable emergency position location data logging communication terminal systems claimed in claim 1, wherein the position locations are presented on a computer map display viewed via the internet.

13. The portable emergency position location data logging communication terminal systems claimed in claim 1, wherein the system automatically transmits emergency distress messages to the emergency dispatch center and emergency points of contact on a recurring basis when the emergency distress button is pressed.

14. The portable emergency position location data logging communication terminal systems claimed in claim 1, wherein the emergency center dispatcher is able to deactivate the emergency distress function.

15. The portable emergency position location data logging communication terminal systems claimed in claim 1, wherein the system is contained in water resistant or water proof container with the shape of a pager.

16. The portable emergency position location data logging communication terminal systems claimed in claim 1, wherein the system is powered by disposable batteries or rechargeable batteries recharged using an external power source.

17. The portable emergency position location data logging communication terminal systems claimed in claim 1, wherein the user of the system can view their location on a map display via the internet and select whether they wish to share their position location information with all other users of the internet map display or keep their position location private.

18. The portable emergency position location data logging communication terminal systems claimed in claim 1, wherein the emergency dispatch center may grant access to the location map display via the internet to emergency responders.

19. The portable emergency position location data logging communication terminal systems claimed in claim 1, wherein the emergency dispatch center can forward the position location data to emergency responder data networks.

20. The portable emergency position location data logging communication terminal systems claimed in claim 1, wherein the position location information can be represented individually or as a grouping on the computer map display.
